(19) United States
(12) Patent Application Publication
(10) Pub. No.: US 2026/0201864 A1
(43) Pub. Date: Jul. 16, 2026

(54) CONTROLLING THE PITCH ANGLE OF A ROTOR BLADE OF A WIND TURBINE

(71) Applicant: VESTAS WIND SYSTEMS A/S, Aarhus N (DK)

(72) Inventors: Christian JEPPESEN, Horsens (DK); John SCHWENSEN, Hadsten (DK); Fabio SPAGNOLO, Aarhus C (DK)

(21) Appl. No.: 19/134,784

(22) PCT Filed: Nov. 30, 2023
(86) PCT No.: PCT/DK2023/050291

§ 371 Date: Jun. 2, 2025

(30) Foreign Application Priority Data
Dec. 2, 2022 (DK) PA202270579

(51) Int. Cl. F03D 7/02; F03D 7/04

(52) U.S. Cl. CPC F03D 7/0224; F03D 7/0298; F03D 7/046; F05B 2270/301; F05B 2270/328; F05B 2270/604

(57) ABSTRACT

The invention provides a method for controlling a pitch angle of a rotor blade (6) of a wind turbine (1) with a hydraulic pitch actuator system (200). The method comprises a step of receiving a current pitch signal of the rotor blade (6) and a pitch reference signal indicating a desired pitch angle for the rotor blade (6), a step of receiving an operating parameter signal (63) from the hydraulic pitch actuator system (200), a step of generating a feedback signal based on the operating parameter signal (63), a step of using a gain scheduler (150) to provide a variable feedback gain, a step of generating a damping signal based on the feedback signal and the variable feedback gain, a step of generating a pitch control command based on a difference between the current pitch signal and the pitch reference signal, and on the damping signal, and a step of sending the pitch control command to the hydraulic pitch actuator system (200).

### TECHNICAL FIELD

The invention relates to a controller for a wind turbine and to a method for controlling a pitch angle of a rotor blade of such a wind turbine.

### BACKGROUND

Wind turbines as known in the art include a wind turbine tower supporting a nacelle and a rotor with a number of—typically, three—pitch-adjustable rotor blades mounted thereto. A controller of the wind turbine is configured to collectively adjust the pitch angles of all rotor blades at once and/or of one or more individual rotor blades only. By pitching the rotor blades into or out of the wind, the controller controls the rotational speed of the rotor. The controller may control a hydraulic pitch actuator system that has a hydraulic cylinder coupled to the rotor blade. The control may involve the opening and closing of a proportional valve for causing a piston in the hydraulic cylinder to be extended or retracted. With this piston movement, the rotor blade is rotated around its longitudinal axis which results in an adjustment of its pitch angle. Generally, the controller is tuned to optimise the tracking performance of the pitch control process, without compromising the pitch position stability.

Larger pitch adjustments may cause a jerking motion in the pitch position of the rotor blade. Such larger pitch amendments may, e.g., occur when switching from partial load to full load or when pitching out the rotor blades to slow down the rotor, e.g., in connection with ceasing the operation of the wind turbine. The jerking motion is also known as ‘pitch hammering’. In some wind turbines, mechanical dampers are provided for avoiding this pitch hammering. Alternatively, as for example described in European patent application EP 3 070 327 A1, damping may be provided by adding a damping signal to the pitch control signal. The damping signal is based on a pitch angle acceleration, which is obtained by calculating the second differential of the actual pitch angle value.

It is against this background that the present invention is set.

### SUMMARY OF THE INVENTION

According to an aspect of the invention there is provided a method for controlling a pitch angle of a rotor blade of a wind turbine. The wind turbine comprises the rotor blade and a hydraulic pitch actuator system, the hydraulic pitch actuator system being operatively coupled to the rotor blade. The method comprises the following steps:
receiving a current pitch signal θ of the rotor blade,
receiving a pitch reference signal θ_{ref} indicating a desired pitch angle for the rotor blade,
receiving an operating parameter signal from the hydraulic pitch actuator system,
generating a feedback signal based on the operating parameter signal,
using a gain scheduler to provide a variable feedback gain,
generating a damping signal based on the feedback signal and the variable feedback gain,
generating a pitch control command based on a difference between the current pitch signal θ and the pitch reference signal θ_{ref}, and on the damping signal, and
sending the pitch control command to the hydraulic pitch actuator system.

The inventors have realised that the pitch hammering may be caused by sudden changes to the hydraulic pitch actuator system and the resulting complex dynamics of the hydraulic fluid in the reconfigured hydraulic system. As a result of these sudden changes, oscillations may occur at specific frequencies depending on the system characteristics of the hydraulic pitch actuator system. According to the invention, an operating parameter signal from the hydraulic pitch actuator system is used to generate a feedback signal that is fed back into the pitch control algorithm. The gain scheduler is used to ensure that a balance is found between optimal tracking performance and stability of the pitch control process. The gain scheduler ensures that the damping is only applied when needed and to the extent needed.

According to various embodiments of the invention, the variable feedback gain is dependent on at least one of:
the current pitch signal θ,
the pitch reference signal θ_{ref},
a current pitch error ε,
a current pitch rate,
a position of a pitch control piston of the hydraulic pitch actuator system,
a rate of change of the position of a pitch control piston,
a wind speed,
a rotor speed or generator speed, and
an operational state of the wind turbine.

For example, the gain scheduler may be designed such that the damping signal provides the strongest damping effect when the rotor blade is pitched close to a full stop and/or close to full load, while no or minimal damping is applied at partial load configurations. Alternatively, the damping may be increased when the pitch error, i.e., a difference between the current pitch signal (θ) and the pitch reference signal (θ_{ref}), increases or when rapid pitch changes are applied. Pitch values and pitch value changes may, e.g., be measured using linear or rotary position and/or acceleration sensors coupled to the rotor blade, or with sensors that monitor the position or movement in the hydraulic actuator for adjusting the pitch angle. There may also be certain operational ranges where a stronger damping is needed than in other operational ranges. It may e.g. be beneficial to apply stronger damping at lower rotor speed than at rated rotor speed. Rotor speed may be used as an indicator for the operational state and there may be a need for stronger damping for state with lower rotational speed, e.g. service state or safe state. The rotor speed may be used as the rotor speed itself or as the generator speed. In another embodiment, the feedback gain may be set based on an operational state of the wind turbine. In this embodiment, the feedback gain may be set as a specific value for a given operational state, such as zero for an operational state where the damping signal is not enabled, and as one for an operational state where the damping signal is fully enabled. In embodiments where gain scheduling is based on more operating parameter signals, a combined gain may be determined by multiplication of the individual gains from the selected operating parameter signals. In this manner, fully enabling of the gain scheduling based on a given operational state may still result in a gain value below 1 if gain scheduling based on a further operating parameter signal is additionally used.

Preferably, the operating parameter signal is a pressure signal from the hydraulic pitch actuator system. The pressure signal may, e.g., be indicative of a pressure in a chamber of a hydraulic actuator of the hydraulic pitch actuator system, or of a pressure difference between two chambers of the hydraulic actuator. Such a pressure signal provides a direct indication of the oscillations and hydraulic disturbances occurring in the hydraulic pitch actuator system and thus is a very suitable input signal for determine an effective damping signal.

In some embodiment, the generating of the feedback signal may comprise applying a high pass filter to the operating parameter signal. The high pass filter may help to ensure that only high frequency fluctuations of the hydraulic pressure and oscillations of the rotor blade pitch are damped, while lower frequency adjustment of the pitch angle are left untouched. The high pass filter functions as an observer of the dynamic part of the operating parameter signal and makes sure that the feedback signal provided to the gain scheduler is independent of the absolute value of the operator parameter signal representing a state of the hydraulic pitch actuator system. Alternatively, instead of a high pass filter, a combination of a differentiator and a lowpass filter, an observer providing a time derivative of the hydraulic pressure, or any other algorithm mimicking a high pass filter may be used.

When using a high pass filter, a corner frequency of the high pass filter may, like the variable feedback gain, be made dependent on at least one of:
the current pitch signal θ,
the pitch reference signal θ_{ref},
a current pitch error ε,
a current pitch rate,
a position of a pitch control piston of the hydraulic pitch actuator system,
a rate of change of the position of a pitch control piston,
a wind speed,
a rotor speed or generator speed, and
an operational state of the wind turbine.

Tuning the corner frequency of the high pass filter in dependence of such, and other, circumstances may help to provide optimal damping performance for the most prevalent oscillation frequencies in the rotor blade and the hydraulic pitch actuator system.

In preferred embodiments, a proportional valve in the hydraulic pitch actuator system is controlled in dependence of the pitch control command. While the rapid opening or closing of such a proportional valve may lead to oscillations of the hydraulic pressure and corresponding mechanical oscillations in the rotor blade, the inventors have found that the damping signals provided in accordance with the current invention provide an effective measure to counteract such oscillations. Consequently, a smooth and accurate adjustment of the pitch angle of the rotor blade is made possible.

The step of generating a pitch control command may, e.g., comprise feeding the difference between the current pitch signal θ and the pitch reference signal θ_{ref} to a pitch reference controller, and adding the damping signal to an output of the pitch reference controller. The pitch reference controller preferably uses a form of deadband compensation. By adding the damping signal to the output of the pitch reference controller, and not directly to the pitch error, it is ensured that the deadband compensation does not diminish the intended effect of the damping signal. In embodiments, the pitch reference controller is a proportional (P) controller, a PI controller, or a PID controller. It may be beneficial to implement the pitch reference controller as a proportional controller, but a PI controller or a PID controller may be used as a alternatives to the proportional controller. The P controller may be beneficial for providing a fast response.

According to a further aspect of the invention, a controller for a wind turbine is provided. The wind turbine comprises a rotor blade and a hydraulic pitch actuator system, the hydraulic pitch actuator system being operatively coupled to the controller and to the rotor blade for controlling a pitch angle of the rotor blade. The controller is configured to perform a method as described above

According to yet another aspect of the invention, a wind turbine is provided comprising such a controller.

### BRIEF DESCRIPTION OF THE DRAWINGS

Examples of the invention will now be described with reference to the accompanying drawings, in which:

FIG. 1 schematically illustrates a wind turbine.

FIG. 2 shows a block diagram of a pitch control system in accordance with an embodiment of the invention.

FIG. 3 shows a block diagram of a pitch control system in accordance with an alternative embodiment of the invention.

FIG. 4 schematically shows a scheduling algorithm that may be used in the pitch control systems of FIGS. 2 and 3.

FIG. 5 shows some test signal values during a pitch adjustment operation in a wind turbine not making use of the current invention.

FIG. 6 shows some test signal values during a pitch adjustment operation in a wind turbine making use of the current invention.

### DETAILED DESCRIPTION

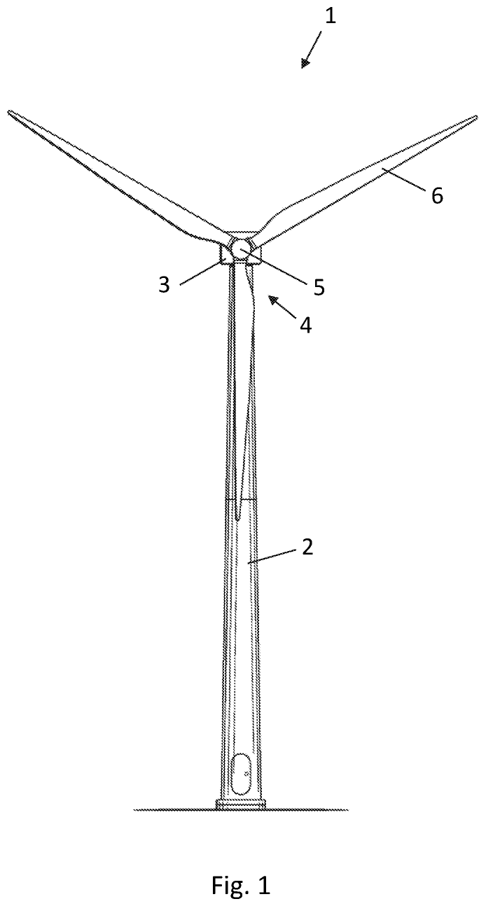

FIG. 1 illustrates, in a schematic view, an example of a wind turbine 1. The wind turbine 1 includes a tower 2, a nacelle 3 disposed at the apex of, or atop, the tower 2, and a rotor 4 operatively coupled to a generator housed inside the nacelle 3. In addition to the generator, the nacelle 3 houses other components required for converting wind energy into electrical energy and various components needed to operate, control, and optimise the performance of the wind turbine 1. The rotor 4 of the wind turbine 1 includes a central hub 5 and three rotor blades 6 that project outwardly from the central hub 5. Moreover, the wind turbine 1 comprises a control system or controller 100 (not shown in FIG. 1). The controller may be placed inside the nacelle 3, in the tower 2 or distributed at several locations inside (or externally to) the turbine 1 and communicatively connected to one another. The rotor blades 6 are individually pitch-adjustable, but can also be adjusted in accordance with a collective pitch setting, where each of the blades are set to the same pitch value. The rotational speed of the rotor 4 can be increased by pitching the rotor blades 6 into the wind or reduced by pitching out.

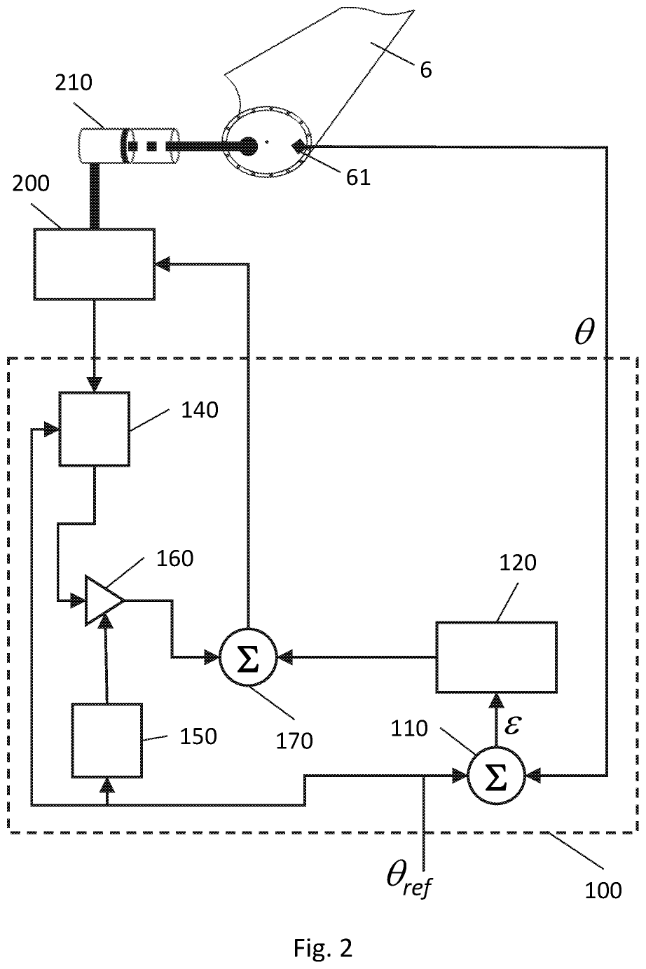

FIG. 2 shows a block diagram of a pitch control system in accordance with an embodiment of the invention. The pitch control system comprises a controller 100, which is configured to receive a current pitch signal θ from a pitch sensor 61 that is coupled to the rotor blade 6. The controller 100 further receives a pitch reference signal θ_{ref} indicating a desired pitch angle for the rotor 6. A subtractor 110 may then use these two signals to calculate a pitch error ε. Based on this pitch error, a pitch control command is calculated using a pitch reference controller 120, with the function of of minimizing any pitch error from the reference. In a preferred embodiment, the pitch reference controller is implemented as a proportional controller which makes use of some form of deadband compensation to prevent oscillations and unnecessary pitch adjustments when the pitch error is very small. In other embodiments, a PI controller or PID controller may be used as an alternative to the proportional controller. In FIG. 2, the deadband compensation is illustrated as a part of the pitch reference controller but may in embodiments be implemented as a dedicated computing block placed at the input side or output side of the pitch reference controller.

The pitch control command instructs a hydraulic pitch actuator system 200 to control a hydraulic actuator 210 for adjusting the pitch angle of the rotor blade 6 and reducing the difference between the current pitch signal θ and the a pitch reference signal θ_{ref}. The hydraulic actuator 210 may, e.g., be a hydraulic cylinder with its piston rod or barrel mounted to the rotor blade 6 and the other side to the central hub 5. The control of the hydraulic actuator 210 may involve the opening and closing of a proportional valve for causing its piston to be extended or retracted. With this piston movement, the rotor blade 6 is rotated around its longitudinal axis which results in an adjustment of its pitch angle. Generally, the controller 100 is tuned to optimise the tracking performance of the pitch control process, without compromising the pitch position stability.

In existing pitch control systems, it has been observed that larger pitch adjustments may cause a jerking motion in the pitch position of the rotor blade 6. Such larger pitch amendments may, e.g., occur when switching from partial load to full load or when pitching out the rotor blades 6 to cease the operation of the wind turbine. This phenomenon is also known as ‘pitch hammering’. One of the possible causes of such jerking motions may be the rapid opening or closing of the proportional valve, which may lead to oscillations of the hydraulic pressure and corresponding mechanical oscillations in the rotor blade 6.

According to an embodiment of the invention, this pitch hammering is avoided, or at least significantly reduced by the introduction of a feedback loop that uses an operating parameter signal from the hydraulic pitch actuator system 200 to generate a damping signal that is used to correct the initial undamped pitch control command. By adding the damping signal to the output of the pitch reference controller 120, and not directly to the pitch error, it is ensured that any deadband compensation that may be used does not diminish the intended effect of the damping signal.

The operating parameter signal may, e.g., be a pressure signal from the hydraulic pitch actuator system 200. The pressure signal may be proportional to a pressure in a chamber of a hydraulic actuator 210 of the hydraulic pitch actuator system 200, or of a pressure difference between two chambers of the hydraulic actuator 210. Such a pressure signal provides a direct indication of the oscillations and hydraulic disturbances occurring in the hydraulic pitch actuator system 200 and thus is a very suitable input signal for determine an effective damping signal. Other signals representative of aspects of the fluid dynamics and changes in the fluid dynamics in the hydraulic pitch actuator system 200 may alternatively be used as the operating parameter signal to be fed into the feedback loop. Alternatively, the pitch signal or the pitch error signal, both being directly linked to the position of the hydraulic actuator 210 may be used as the operating parameter signal.

Preferably, only the dynamic part of the pressure signal, or of whichever other operating parameter signal that is being used, serves as a basis for generating the damping signal. For example, a high a high pass filter 140 may process the pressure signal, thereby ensuring that only high frequency fluctuations of the hydraulic pressure and oscillations of the rotor blade pitch are damped, while lower frequency adjustment of the pitch angle are left untouched. The high pass filter 140 functions as an observer of the dynamic part of the operating parameter signal and makes sure that the feedback signal used for generating the damping signal is independent of the absolute value of the pressure signal. Alternatively, instead of a high pass filter 140, a combination of a differentiator and a lowpass filter, an observer providing a time derivative of the hydraulic pressure, or any other algorithm mimicking a high pass filter 140 may be used.

A corner frequency of the high pass filter 140 may be made dependent on one or more parameters relating to the pitch angle of the rotor blade 6, a configuration of the hydraulic pitch actuator system 200, weather conditions, wind turbine power output, or other relevant aspects of the operation of the wind turbine 1. Predetermined formulas or lookup tables may be used for determining a suitable corner frequency based on one or more of such parameters. The corner frequency of the high pass filter 140 is, e.g., dependent on at least one of:
the current pitch signal θ,
the pitch reference signal θ_{ref},
a current pitch error ε,
a current pitch rate,
a position of a pitch control piston of the hydraulic pitch actuator system,
a rate of change of the position of the pitch control piston,
a wind speed,
a rotor speed or generator speed, and
an operational state of the wind turbine.

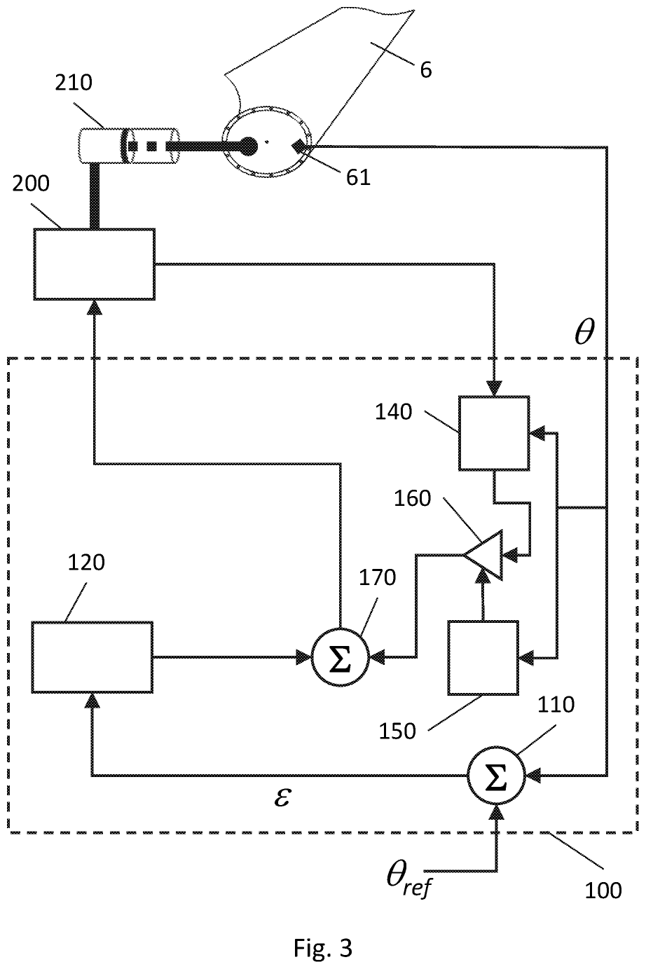

Tuning the corner frequency of the high pass filter in dependence of such circumstances may help to provide optimal damping performance for the most prevalent oscillation frequencies in the rotor blade 6 and the hydraulic pitch actuator system 200. In the embodiment shown in FIG. 2, the pitch reference signal θ_{ref} is used as a basis for determining the corner frequency of the high pass filter 140. In the alternative embodiment shown in FIG. 3, the current pitch signal θ determines the corner frequency.

A gain scheduler 150 provides a variable feedback gain that may depend on one or more parameters relating to the pitch angle of the rotor blade 6, a configuration of the hydraulic pitch actuator system 200, weather conditions, wind turbine power output, or other relevant aspects of the operation of the wind turbine 1. Based on the variable feedback gain from the gain scheduler 150 and the feedback signal from the high pass filter 140 or an alternative observer of the dynamic part of the operating parameter signal, an amplifier 160 generates a damping signal. The damping signal is then added by an adder 160 to produce the dampened pitch control command. Finally, the dampened pitch control command is sent to the hydraulic pitch actuator system 200 in order to allow the pitch error to be corrected with a minimum of unwanted oscillations.

The purpose of the variable feedback gain thus is to only dampen the initial pitch control command coming from the pitch reference controller 120 in situations where pitch hammering occurs or is expected to occur. The gain scheduler 150 is thus used to ensure that a balance is found between optimal tracking performance and stability of the pitch control process. Damping is only applied when needed and to the extent needed.

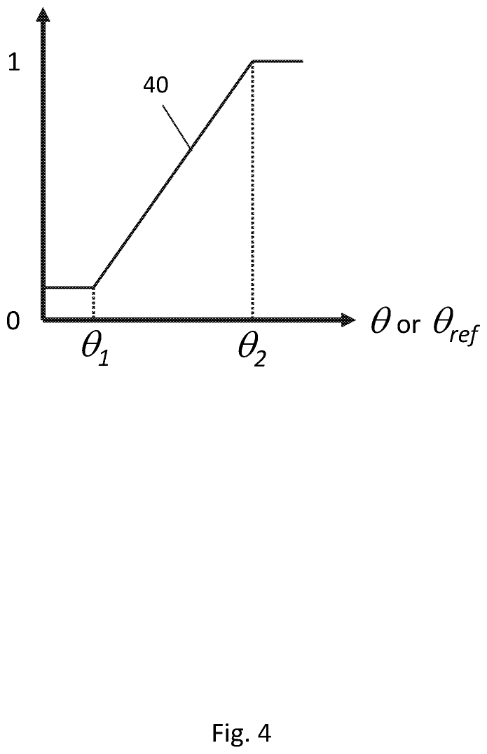

FIG. 4 schematically shows a scheduling algorithm 40 that may be used in the pitch control systems of FIGS. 2 and 3. In this exemplary scheduler, the variable feedback gain depends on either the pitch reference signal θ_{ref} (FIG. 2 embodiment) or the current pitch signal θ (FIG. 3 embodiment). Up to a first pitch (reference) angle θ₁ the variable feedback gain is minimal (i.e., zero or some low base value) and damping will be minimal, thereby resulting in a high responsiveness of the damping algorithm. As the pitch (reference) angle gets higher, the variable feedback gain starts to increase and the damping gets stronger. From a second pitch (reference) angle θ₂ the variable feedback gain is at its maximum value of, e.g., 1. and maximum damping is applied.

In other embodiments, the scheduling algorithm 40 may, e.g., be non-linear and/or depend on more than one variable. The variables defining the variable feedback gain may include one or more parameters relating to the pitch angle of the rotor blade 6, a configuration of the hydraulic pitch actuator system 200, weather conditions, wind turbine power output, or other relevant aspects of the operation of the wind turbine 1. Predetermined formulas or lookup tables may be used for determining a suitable variable feedback gain based on one or more of such parameters. The variable feedback gain is, e.g., dependent on at least one of:
the current pitch signal (θ),
the pitch reference signal (θ_{ref}),
a current pitch error,
a current pitch rate,
a position of a pitch control piston of the hydraulic pitch actuator system,
a rate of change of the position of the pitch control piston,
a wind speed,
a rotor speed or generator speed, and
an operational state of the wind turbine.

For example, the gain scheduler 150 may be designed such that the damping signal provides the strongest damping effect when the rotor blade 6 is pitched close to a full stop and/or close to full load, while no or minimal damping is applied at partial load configurations. Alternatively, the damping may be increased when the pitch error increases or when rapid pitch changes are applied. Pitch values and pitch value changes may, e.g., be measured using linear or rotary position and/or acceleration sensors coupled to the rotor blade 6, or with sensors that monitor the position or movement in the hydraulic actuator 210 for adjusting the pitch angle.

FIG. 4 shows a piecewise linear function, a gain function may however also be implemented as a smooth function or as a stepped function. For example, if the input variable is an operational state, the gain may be set to a given value depending on the operational state, e.g. as zero for a state where gain scheduling is not enabled and as one for a state where gain scheduling is fully enabled.

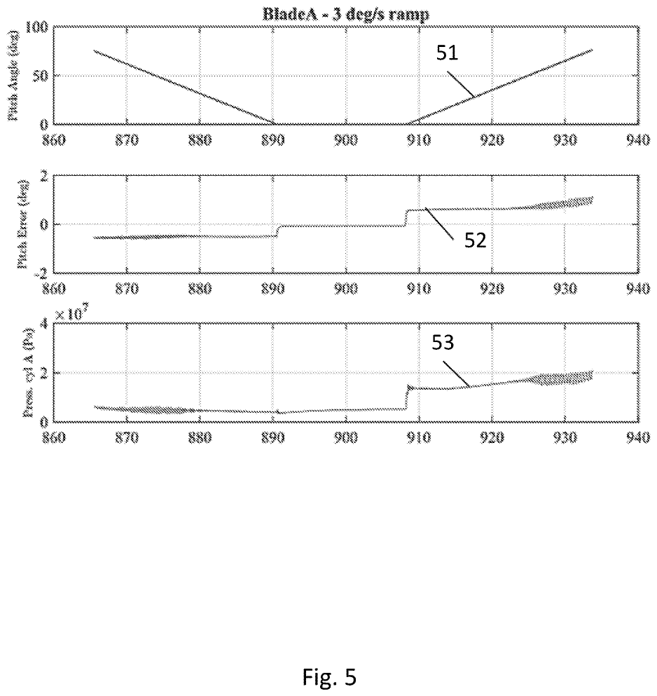

FIG. 5 shows some test signal values 51, 52, 53 during a pitch adjustment operation in a wind turbine 1 not making use of the current invention. The top diagram in FIG. 5 shows how a pitch signal or pitch reference signal 51, when pitching the rotor blade 6 from a pitch angle of about 70 to a pitch angle of 0° and back to 70 over a period of, in total, slightly below 70 seconds. The second diagram shows how a pitch error signal 52 during this transition. The pitch error signal 52 indicates that, in this test for this particular wind turbine 1, the actual pitch angle typically lags a little bit (less than 1°) behind the pitch reference while the pitch angle is being adjusted and is close to or equal to 0° when the rotor pitch angle is kept constant. From this pitch error signal 52, it can be seen that the rotor blade pitch starts oscillating when the rotor 5 approaches, or moves away from, a full stop. In the third diagram, which shows a pressure signal 53 from one of the chambers of the hydraulic actuator 210, it can be seen that these rotor blade pitch oscillations co-occur with oscillations in the pressure signal 53. This pressure signal 53, or any suitable other operating parameter signal from the hydraulic pitch actuator system 200, can be used as input for the feedback loop providing the damping signal of the current the invention.

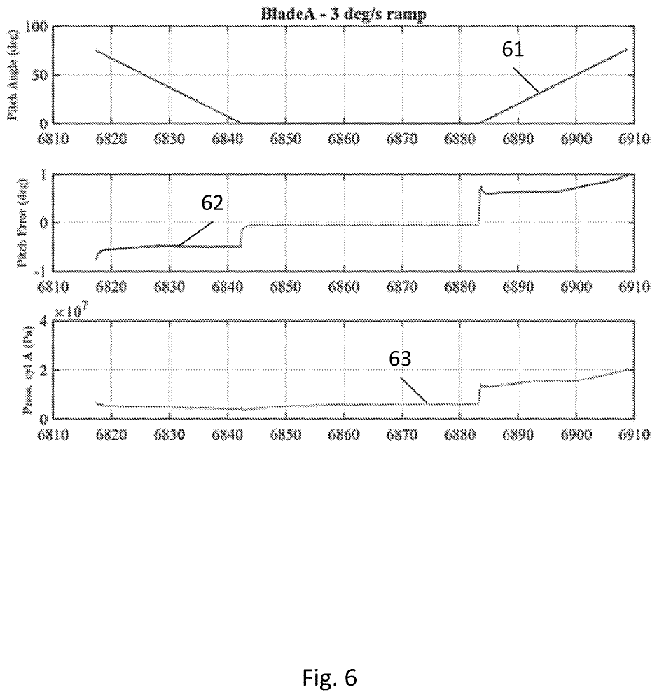

FIG. 6 shows some test signal values during a pitch adjustment operation in a wind turbine 1 that does make use of the current invention. As the pitch or pitch reference signal 61 shows, the same pitch adjustments are made as for the tests represented in FIG. 5, at the same pitch rate of about 3° per second. From the pitch error signal 62 in FIG. 6, it can be seen that the damping provided in accordance with the current invention effectively removes the rotor blade pitch oscillations observed in the pitch error signal 52 of the undamped test of FIG. 5. As can be observed in the pressure signal 63 from one of the chambers of the hydraulic actuator 210, the damping provided in accordance with the current invention ensures a more stable fluid dynamics in the hydraulic pitch actuator system 200.

1. A method for controlling a pitch angle of a rotor blade of a wind turbine, the wind turbine comprising the rotor blade and a hydraulic pitch actuator system, the hydraulic pitch actuator system being operatively coupled to the rotor blade, the method comprising:
receiving a current pitch signal of the rotor blade,
receiving a pitch reference signal indicating a desired pitch angle for the rotor blade,
receiving an operating parameter signal from the hydraulic pitch actuator system,
generating a feedback signal based on the operating parameter signal,
using a gain scheduler to provide a variable feedback gain,
generating a damping signal based on the feedback signal and the variable feedback gain,
generating a pitch control command based on a difference between the current pitch signal and the pitch reference signal, and on the damping signal, and
sending the pitch control command to the hydraulic pitch actuator system.

2. A method according to claim 1, wherein the variable feedback gain is dependent on at least one of:
the current pitch signal,
the pitch reference signal,
a current pitch error,
a current pitch rate,
a position of a pitch control piston of the hydraulic pitch actuator system,
a rate of change of the position of the pitch control piston,
a wind speed,
a rotor speed or generator speed, and
an operational state of the wind turbine.

3. A method according to claim 1, wherein the operating parameter signal is a pressure signal from the hydraulic pitch actuator system.

4. A method according to claim 3, wherein the pressure signal is indicative of a pressure in a chamber of a hydraulic actuator of the hydraulic pitch actuator system, or of a pressure difference between two chambers of the hydraulic actuator.

5. A method according to claim 1, wherein the current pitch signal or current pitch error signal is the operating parameter signal.

6. A method according to claim 1, wherein the generating of the feedback signal comprises applying a high pass filter to the operating parameter signal.

7. A method according to claim 6, wherein a corner frequency of the high pass filter is dependent on at least one of:
the current pitch signal,
the pitch reference signal,
a current pitch error,
a current pitch rate,
a position of a pitch control piston of the hydraulic pitch actuator system,
a rate of change of the position of the pitch control piston,
a wind speed,
a rotor speed or generator speed, and
an operational state of the wind turbine.

8. A method according to claim 1, wherein the generating of the feedback signal comprises applying a combination of a differentiator and a lowpass filter, or an observer providing a time derivative of the hydraulic pressure to the operating parameter signal.

9. A method according to claim 1, further comprising controlling a proportional valve in the hydraulic pitch actuator system in dependence of the pitch control command.

10. A method according to claim 1, wherein the step of generating a pitch control command comprises feeding the difference between the current pitch signal and the pitch reference signal to a pitch reference controller, and adding the damping signal to an output of the pitch reference controller.

11. A method according to claim 10, wherein the pitch reference controller uses deadband compensation.

12. A controller for a wind turbine comprising a rotor blade and a hydraulic pitch actuator system, the hydraulic pitch actuator system being operatively coupled to the controller and to the rotor blade for controlling a pitch angle of the rotor blade, the controller being configured to perform an operation, comprising:
receiving a current pitch signal of the rotor blade;
receiving a pitch reference signal indicating a desired pitch angle for the rotor blade;
receiving an operating parameter signal from the hydraulic pitch actuator system;
generating a feedback signal based on the operating parameter signal;
using a gain scheduler to provide a variable feedback gain;
generating a damping signal based on the feedback signal and the variable feedback gain;
generating a pitch control command based on a difference between the current pitch signal and the pitch reference signal, and on the damping signal; and
sending the pitch control command to the hydraulic pitch actuator system.

13. (canceled)

14. (canceled)

15. A wind turbine, comprising:
a tower;
a nacelle disposed on the tower;
a rotor extending from the nacelle;
a rotor blade;
coupled to the rotor;
a controller;
a hydraulic pitch actuator system operatively coupled to the controller and to the rotor blade for controlling a pitch angle of the rotor blade;
wherein the controller is configured to perform an operation, comprising:
receiving a current pitch signal of the rotor blade;
receiving a pitch reference signal indicating a desired pitch angle for the rotor blade;
receiving an operating parameter signal from the hydraulic pitch actuator system;
generating a feedback signal based on the operating parameter signal;
using a gain scheduler to provide a variable feedback gain;
generating a damping signal based on the feedback signal and the variable feedback gain;
generating a pitch control command based on a difference between the current pitch signal and the pitch reference signal, and on the damping signal; and
sending the pitch control command to the hydraulic pitch actuator system.

16. A non-transitory, computer-readable storage medium storing instructions thereon that when executed by one or more processors cause the one or more processors to execute an operation for controlling a pitch angle of a rotor blade of a wind turbine, the wind turbine comprising the rotor blade and a hydraulic pitch actuator system, the hydraulic pitch actuator system being operatively coupled to the rotor blade, the operation comprising:
receiving a current pitch signal of the rotor blade;
receiving a pitch reference signal indicating a desired pitch angle for the rotor blade;
receiving an operating parameter signal from the hydraulic pitch actuator system;
generating a feedback signal based on the operating parameter signal;
using a gain scheduler to provide a variable feedback gain;
generating a damping signal based on the feedback signal and the variable feedback gain;
generating a pitch control command based on a difference between the current pitch signal and the pitch reference signal, and on the damping signal; and
sending the pitch control command to the hydraulic pitch actuator system
